(19) United States
(12) Patent Application Publication
(10) Pub. No.: US 2025/0207559 A1
(43) Pub. Date: Jun. 26, 2025

(54) WIND TURBINE WITH CONTROL NETWORK AND MONITORING NETWORK

(71) Applicant: VESTAS WIND SYSTEMS A/S, Aarhus N (DK)

(72) Inventors: Peter Delgado GROVE, Hinnerup (DK); Henrik Althof KNUDSEN, Rønde (DK)

(21) Appl. No.: 18/852,160

(22) PCT Filed: Mar. 24, 2023
(86) PCT No.: PCT/DK2023/050053

§ 371 Date: Sep. 27, 2024

(30) Foreign Application Priority Data
Mar. 28, 2022 (DK) PA202270144

(51) Int. Cl. F03D 7/02; F03D 17/00; F03D 80/80; H04J 14/02

(52) U.S. Cl. CPC F03D 7/02; F03D 17/00; F03D 80/821; H04J 14/0307

(57) ABSTRACT

A wind turbine comprising a control network is provided. The control network comprising control-network nodes with one or more control-network nodes in the rotor and one or more control-network nodes in the nacelle. A monitoring network is also provided, comprising monitoring-network nodes with one or more monitoring-network nodes in the rotor and one or more monitoring-network nodes in the nacelle. An optical fibre is shared by the two networks and extends between the nacelle and the rotor. First and second wavelength division multiplexer/demultiplexers are provided in the rotor and in the nacelle.

### FIELD OF THE INVENTION

The present invention relates to a wind turbine comprising a control network and a monitoring network. The invention also relates to a method of handling communication signals in networks of a wind turbine.

### BACKGROUND OF THE INVENTION

A wind turbine may utilize optical communication systems for various purposes, typically in the form of communication of control signals and communication of monitoring signals. Such signals may be handled by dedicated communication networks. Communication between control and monitoring networks of a wind turbine should ideally be prevented in order to comply with cyber-security standards.

### SUMMARY OF THE INVENTION

A first aspect of the invention provides a wind turbine comprising: a nacelle; a rotor rotationally mounted to the nacelle, the rotor comprising a hub, and blades extending from the hub; a control network comprising control-network nodes connected by a first network, the control-network nodes comprising one or more first control-network nodes in the rotor and one or more second control-network nodes in the nacelle; a monitoring network comprising monitoring-network nodes connected by a second network, the monitoring-network nodes comprising one or more first monitoring-network nodes in the rotor and one or more second monitoring-network nodes in the nacelle; an optical fibre which is shared by the first and second networks and extends between the nacelle and the rotor; a first wavelength division multiplexer/demultiplexer in the rotor; and a second wavelength division multiplexer/demultiplexer in the nacelle, wherein: the first wavelength division multiplexer/demultiplexer is configured to receive nacelle-bound light and multiplex the nacelle-bound light onto the optical fibre; the first wavelength division multiplexer/demultiplexer is configured to demultiplex rotor-bound light from the optical fibre and route it to either the control network or the monitoring network based on a wavelength of the rotor-bound light; the second wavelength division multiplexer/demultiplexer is configured to demultiplex the nacelle-bound light from the optical fibre and route it to either the control network or the monitoring network based on a wavelength of the nacelle-bound light; and the second wavelength division multiplexer/demultiplexer is configured to multiplex the rotor-bound light onto the optical fibre.

Optionally at least one of the first monitoring-network nodes and at least one of the second monitoring-network nodes comprises a monitoring element configured to monitor the wind turbine and generate monitoring data.

Optionally the second network is configured to receive the monitoring data and communicate the monitoring data to a substation remote from the wind turbine.

Optionally the second network is configured to communicate monitoring network data to the monitoring-network nodes.

Optionally the monitoring network data comprises configuration data or command data.

Optionally at least one of the first control-network nodes and at least one of the second control-network nodes comprises a control element configured to control the wind turbine based on control data, and the first optical fibre network is configured to communicate the control data to the control elements.

Optionally the first wavelength division multiplexer/demultiplexer and/or the second wavelength division multiplexer/demultiplexer is configured to operate passively.

Optionally the optical fibre is a multi-mode optical fibre.

Optionally the first wavelength division multiplexer/demultiplexer is in the hub.

Optionally the control network and the monitoring network each comprise a respective transmitter in the rotor, and the transmitters in the rotor are configured to generate the nacelle-bound light at respective wavelengths and feed it to the first wavelength division multiplexer/demultiplexer.

Optionally the control network and the monitoring network each comprise a respective transmitter in the nacelle, and the transmitters in the nacelle are configured to generate the rotor-bound light at respective wavelengths and feed it to the second wavelength division multiplexer/demultiplexer.

Optionally the control network and the monitoring network each comprise a respective receiver in the rotor, and the receivers in the rotor are each configured to receive the rotor-bound light at respective wavelengths from the first wavelength division multiplexer/demultiplexer and convert the rotor-bound light into an electrical signal.

Optionally the control network and the monitoring network each comprise a respective receiver in the nacelle, and the receivers in the nacelle are each configured to receive the nacelle-bound light at respective wavelengths from the second wavelength division multiplexer/demultiplexer and convert the nacelle-bound light into an electrical signal.

A further aspect of the invention provides a method of handling communication signals in networks of a wind turbine, the wind turbine comprising: a nacelle; a rotor rotationally mounted to the nacelle, the rotor comprising a hub, and blades extending from the hub; a control network comprising control-network nodes connected by a first network, the control-network nodes comprising one or more first control-network nodes in the rotor and one or more second control-network nodes in the nacelle; a monitoring network comprising monitoring-network nodes connected by a second network, the monitoring-network nodes comprising one or more first monitoring-network nodes in the rotor and one or more second monitoring-network nodes in the nacelle; and an optical fibre which is shared by the first and second networks and extends between the nacelle and the rotor, the method comprising: receiving nacelle-bound light and multiplexing the nacelle-bound light onto the optical fibre; demultiplexing rotor-bound light from the optical fibre and routing it to either the control network or the monitoring network based on a wavelength of the rotor-bound light; demultiplexing the nacelle-bound light from the optical fibre and routing it to either the control network or the monitoring network based on a wavelength of the nacelle-bound light; and multiplexing the rotor-bound light onto the optical fibre.

### BRIEF DESCRIPTION OF THE DRAWINGS

Embodiments of the invention will now be described with reference to the accompanying drawings, in which:

FIG. 1 shows a wind turbine

FIG. 2 shows a control system of the wind turbine;

FIG. 3 shows elements of a monitoring network and a control network of the wind turbine;

FIG. 4 shows the monitoring network and control network in more detail; and

FIG. 5 shows the optical transceiver/diplexers in detail.

### DETAILED DESCRIPTION OF EMBODIMENT(S)

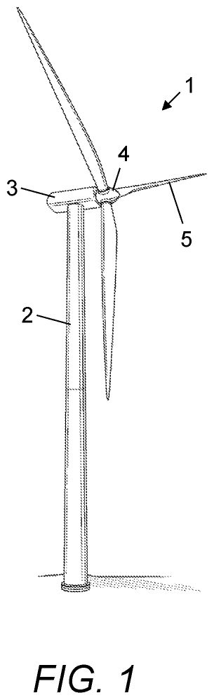

FIG. 1 shows a wind turbine 1 comprising a nacelle 3 mounted on a tower 2. A rotor 4, 5 is rotationally mounted to the nacelle 3. The rotor comprises a hub 4, and blades 5 extending from the hub. In this example, the rotor comprises three blades 5. The nacelle 3 can be rotated about a vertical yaw axis to change its yaw angle.

The wind turbine 1 may be included among a collection of other wind turbines belonging to a wind power plant, also referred to as a wind farm or wind park, that serve as a power generating plant connected by transmission lines with a power grid. The power grid generally consists of a network of power stations, transmission circuits, and substations coupled by a network of transmission lines that transmit the power to loads in the form of end users and other customers of electrical utilities.

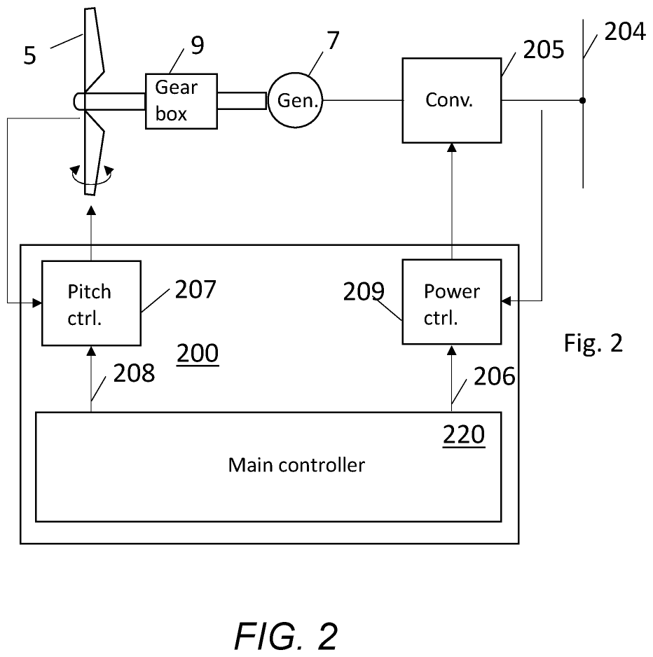

FIG. 2 schematically illustrates an embodiment of a control system 200 together with elements of the wind turbine 1. The rotor 4, 5 is mechanically connected to an electrical generator 7 via a gearbox 9. The electrical power generated by the generator 7 is injected into a power grid 204 via an electrical converter 205. The electrical generator 7 and the converter 205 may be based on a full scale converter (FSC) architecture or a doubly fed induction generator (DFIG) architecture, but other types may be used.

The control system 200 comprises a number of elements, including at least one main controller 220 with a processor and a memory, so that the processor is capable of executing computing tasks based on instructions stored in the memory. In general, the main controller 220 ensures that in operation the wind turbine generates a requested power output level. This is obtained by adjusting the pitch angle of the blades and/or the power extraction of the converter 205. To this end, the control system 200 comprises a pitch system including a pitch controller 207 using a pitch reference signal 208, and a power system including a power controller 209 using a power reference signal 206. The rotor blades 5 can be pitched by a pitch mechanism. The rotor comprises an individual pitch system which is capable of individual pitching of the rotor blades 5, and may comprise a common pitch system which adjusts all pitch angles on all rotor blades at the same time. The control system 200, or elements of the control system 200, may be placed in a power plant controller (not shown) so that the turbine may be operated based on externally provided instructions.

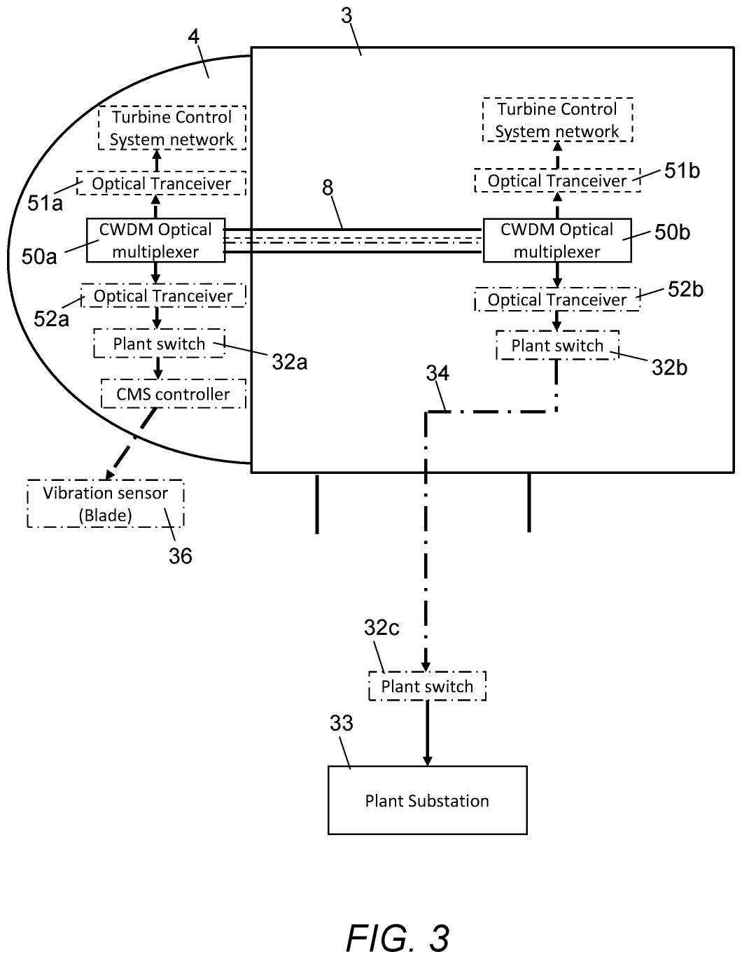

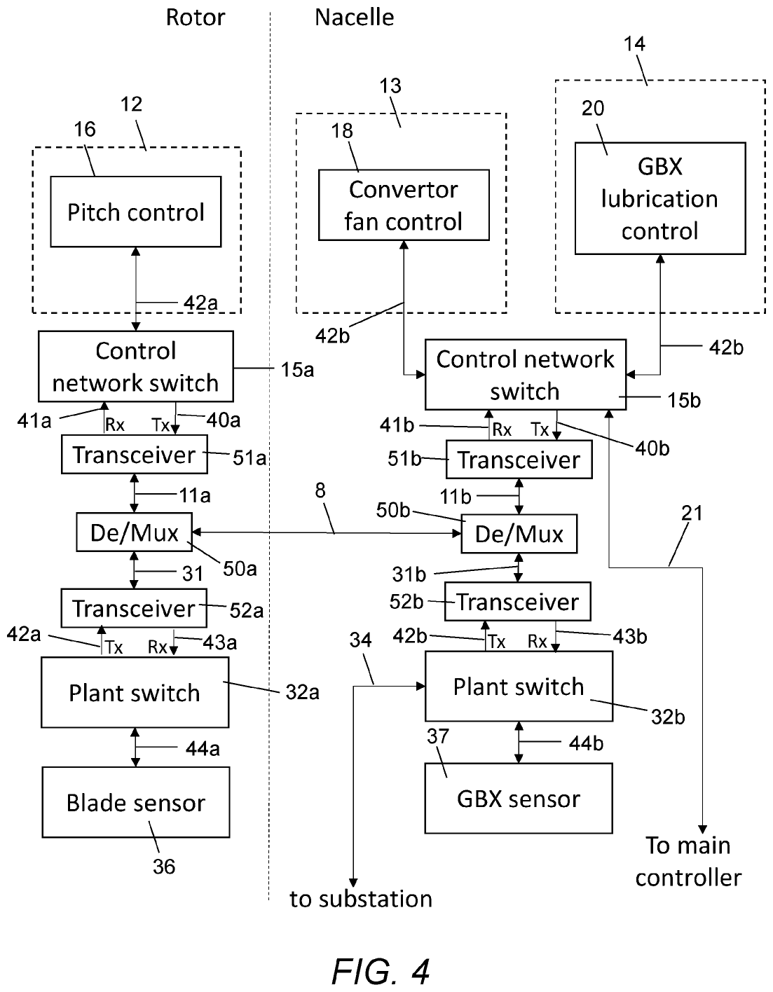

The wind turbine 1 comprises a control network and a monitoring network, which are shown at different levels of detail in FIGS. 3 and 4. The control network may be configured to control the wind turbine 1; and the monitoring network may be configured to monitor the wind turbine.

An example of the control network is shown in the top part of FIG. 4. The control network comprises one or more first control-network nodes 12 in the rotor (for instance, in the hub 4) and one or more second control-network nodes 13 in the nacelle 3. The control-network nodes 12, 13 are connected by a first network. The first network has an optical fibre backbone which comprises an optical fibre 11a in the hub, an optical fibre 11b in the nacelle, and a linking optical fibre 8 which extends between the nacelle 3 and the hub 4. The linking optical fibre 8 may be a multi-mode optical fibre or a single-mode optical fibre. The first network also comprises various electrical communication lines including transmit lines 40a, 40b; receive lines 41a, 41b; and connector lines 42a, 42b.

The control network in the rotor comprise a first optical transceiver/diplexer 51a, a first control network switch 15a, and one or more first control-network nodes 12 connected to the first control network switch 15a. In this example only a single control-network node 12 is shown in the rotor, but in other embodiments further control-network nodes in the rotor may be connected to the first control network switch 15a.

The (or each) first control-network node in the rotor may comprise a distributed control-network node (DCN) 12 with a control element configured to control the wind turbine based on control data from the main controller 220, or any other turbine control system or element. The first network 11a, 11b, 8, 40b, 41a may be configured to communicate this control data to the DCN(s) 12 in the rotor. In this example the control data is received from the main controller 220 via a line 21 into a second control network switch 15b in the nacelle.

In the example of DCN 12, the control element may be a blade pitch control 16 which adjusts the pitch of the blades 5 based on the control data.

One or more of the first control-network nodes in the rotor may transmit as well as receive information. For example one or more of the DCNs 12 may be configured to generate configuration data which is communicated to the main controller 220, or another element of the wind turbine, by the first network 11a, 11b, 8, 40a, 41b.

In this example the first control-network nodes in the rotor are in the hub 4, but alternatively one or more of the first control-network nodes may be in another part of the rotor, such as a blade 5.

The control network in the nacelle comprise a second optical transceiver/diplexer 51b, a second control network switch 15b, and one or more second control-network nodes 13, 14 connected to the second control network switch 15b. In this example two second control-network nodes 13, 14 are shown in the nacelle, but in other embodiments there may be only a single second control-network node in the nacelle, or more than two.

The (or each) second control-network node in the nacelle may comprise a distributed control-network node (DCN) 13, 14 with a control element configured to control the wind turbine based on control data. The optical fibre 11b of the first network in the nacelle may be configured to communicate the control data to the DCN(s) 13, 14 in the nacelle.

In the example of DCN 13, the control element may be a converter fan control 18 which adjusts the power of a converter fan (which cools the converter 205) based on the control data.

In the example of DCN 14, the control element may be a gearbox lubrication control 20 which controls the lubrication of the gearbox 9.

One or more of the second control-network nodes in the nacelle may transmit as well as receive information. For example one or more of the DCNs 13, 14 may be configured to generate configuration data which is communicated to the main controller 220, or another element of the wind turbine, by the second control network switch 15b.

In this example each DCN 12, 13, 14 of the control network may optionally include control elements configured to control the wind turbine, but other control-network nodes may be provided as part of the control network which perform different functions depending on their position. Therefore the term “control-network node” designates a node which is part of the control network, but does not necessarily directly perform a control function.

An example of the monitoring network is shown in the bottom part of FIG. 4. The monitoring network comprises one or more first monitoring-network nodes 36 in the rotor 4 and one or more second monitoring-network nodes 37 in the nacelle 3. The monitoring-network nodes of the monitoring network are connected by a second network. The second network has an optical fibre backbone comprising an optical fibre 31a in the hub, an optical fibre 31b in the nacelle, and the linking optical fibre 8 which is shared by the first and second networks. The second network also comprises various electrical communication lines including transmit lines 42a, 42b; receive lines 43a, 43b; and sensor connector lines 44a, 44b.

The monitoring network in the rotor comprises a first optical transceiver/diplexer 52a, a first plant switch 32a, and one or more first monitoring-network nodes 36 connected to the first plant switch 32a. In this example only a single first monitoring-network node 36 is shown in the rotor, but in other embodiments further monitoring-network nodes in the rotor may be connected to the first plant switch 32a.

Each first monitoring-network node in the hub may comprise a monitoring element, such as a sensor, configured to monitor the wind turbine and generate monitoring data. The second network 31a, 31b, 8, 44a, 42a, 43b may be configured to receive the monitoring data from the first monitoring-network node(s) 36 in the rotor and communicate the monitoring data to a plant substation 33 remote from the wind turbine 1. The monitoring data may be output via a second plant switch 32b in the nacelle and a third plant switch 32c at the foot of the tower 2 (the third plant switch 32c and plant substation 33 are shown in FIG. 3).

In this example the first monitoring-network node in the rotor may be a blade vibration sensor 36 in one of the blades 5 which measures vibration of one or more of the blades 5.

In this example the first monitoring-network node 36 is located in a blade 5, but alternatively one or more of the first monitoring-network node(s) in the rotor may be in another part of the rotor, such as the hub 4.

One or more of the first monitoring-network nodes in the rotor may receive as well as transmit information. For example the second network may be configured to communicate monitoring network data, such as configuration data or command data, from the main controller 220 to the first monitoring-network node(s) 36 in the rotor.

The monitoring network in the nacelle comprises a second optical transceiver/diplexer 52b, a second plant switch 32b, and one or more second monitoring-network nodes 37 connected to the second plant switch 32b. In this example only a single second monitoring-network node 37 is shown in the nacelle, but in other embodiments further monitoring-network nodes in the nacelle may be connected to the second plant switch 32b.

Each second monitoring-network node 37 in the nacelle may comprise a monitoring element, such as a sensor, configured to monitor the wind turbine and generate monitoring data. The second plant switch 32b may be configured to receive the monitoring data from the first monitoring-network node(s) 37 in the nacelle and communicate the monitoring data to the plant substation 33 via the third plant switch 32c shown in FIG. 3.

In this example the second monitoring-network node in the nacelle may be a gearbox vibration sensor 37 which measures vibration of the gearbox 9.

Further monitoring elements in the nacelle may measure the rotation rate of the generator 7, temperature, oil levels and/or power output.

In this example, no control functions are performed by the monitoring network.

The second monitoring-network nodes 37 in the nacelle may receive as well as transmit information. For example the second network may be configured to communicate monitoring network data, such as configuration data or command data, from the main controller 220 to the second monitoring-network node(s) 37 in the nacelle.

In this example each monitoring-network node 36, 37 may optionally include a monitoring element configured to configured to monitor the wind turbine, but other monitoring-network nodes may be provided as part of the monitor network which perform different functions depending on their position. Therefore the term “monitoring-network node” designates a node which is part of the monitor network, but does not necessarily directly perform a monitoring function.

Optionally the monitoring network is functionally separate from the control network, so that communication between the networks is prevented in order to comply with cyber-security standards. This prevents a cyber-attack on the monitoring network, whereby access is gained to the control network via the monitoring network, thus jeopardizing safe control of the wind turbine.

Since the rotor 4, 5 is rotationally mounted to the nacelle 3, the linking optical fibre 8 requires an optical fibre rotating joint. One way of keeping the monitoring network functionally separate from the control network would be for each network to have its own dedicated linking optical fibre. A problem with this alternative solution is that it would require a second linking optical fibre and a multi-channel optical rotating joint.

In the case of FIGS. 3 and 4, a single linking optical fibre 8 between the nacelle and the rotor is shared by the first and second networks.

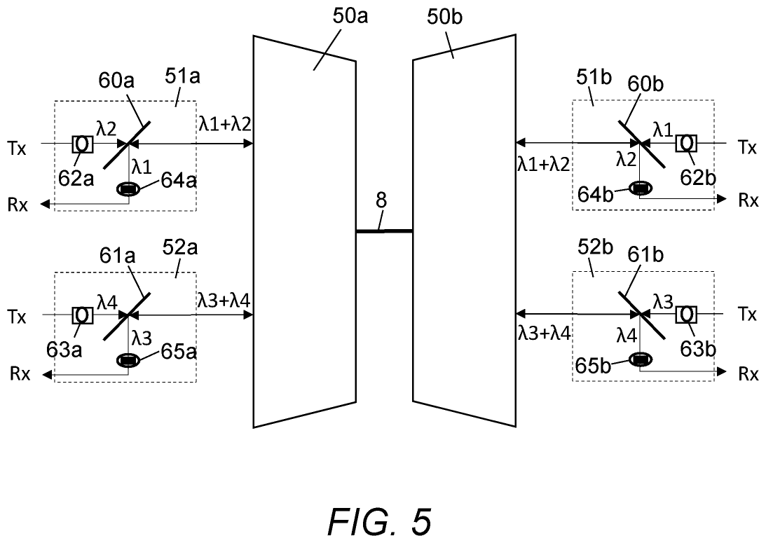

A first wavelength division multiplexer/demultiplexer 50a is provided in the rotor; and a second wavelength division multiplexer/demultiplexer 50b is provided in the nacelle. The multiplexer/demultiplexers 50a, 50b are each connected to the linking optical fibre 8, and optical transceiver/diplexers 51a, 51b, 52a, 52b which are shown in detail in FIG. 5.

The control network and the monitoring network each comprise a respective transceiver/diplexer 51a, 52a in the rotor and a respective transceiver/diplexer 51b, 52b in the nacelle.

Each transceiver/diplexer comprises a diplexer 60a, 60b, 61a, 61b; a transmitter 62a, 62b, 63a, 63b (such as a laser) and a receiver 64a, 64b, 65a, 65b (such as an optical receiver).

The transmitters 62a, 62b, 63a, 63b are each configured to generate light at a respective wavelength and feed it into the linking optical fibre 8 via one of the multiplexer/demultiplexers 50a, 50b. This light is either nacelle-bound light (travelling from the rotor to the nacelle) or rotor-bound light (travelling from the nacelle to the rotor).

Each transmitter may convert a respective electrical communication signal into a respective optical communication signal, as explained below.

More specifically: the transmitter 62a of the control network in the rotor may be configured to receive an electrical transmit signal from the control network on transmit line 40a, use the transmit signal to generate nacelle-bound light at a wavelength λ2, and feed it to the first wavelength division multiplexer/demultiplexer 50a via the diplexer 60a.

The transmitter 63a of the monitoring network in the rotor may be configured to receive an electrical transmit signal from the monitoring network on transmit line 42a, use the transmit signal to generate nacelle-bound light at a wavelength λ4, and feed it to the first wavelength division multiplexer/demultiplexer 50a via the diplexer 61a.

The transmitter 62b of the control network in the nacelle may be configured to receive an electrical transmit signal from the control network on transmit line 40b, use the transmit signal to generate rotor-bound light at a wavelength λ1, and feed it to the second wavelength division multiplexer/demultiplexer 50b via the diplexer 60b.

The transmitter 63b of the monitoring network in the nacelle may be configured to receive an electrical transmit signal from the monitoring network on transmit line 42b, use the transmit signal to generate nacelle-bound light at a wavelength λ3, and feed it to the second wavelength division multiplexer/demultiplexer 50b via the diplexer 61b.

The receivers 64a, 64b, 65a, 65b may each be configured to receive light from the linking optical fibre 8 and convert it into an electrical signal.

Each receiver may convert a respective optical communication signal into a respective electrical communication signal, as explained below.

More specifically: the receiver 64a of the control network in the rotor may be configured to receive the rotor-bound light at wavelength λ1 from the first wavelength division multiplexer/demultiplexer 50a and convert it into an electrical signal which it outputs on receive line 41a.

The receiver 65a of the monitoring network in the rotor may be configured to receive the rotor-bound light at wavelength λ3 from the first wavelength division multiplexer/demultiplexer 50a and convert it into an electrical signal which it outputs on receive line 43a.

The receiver 64b of the control network in the nacelle may be configured to receive the nacelle-bound light at wavelength λ2 from the second wavelength division multiplexer/demultiplexer 50b and convert it into an electrical signal which it outputs on receive line 41b.

The receiver 65b of the monitoring network in the nacelle may be configured to receive the nacelle-bound light at wavelength λ4 from the second wavelength division multiplexer/demultiplexer 50b and convert it into an electrical signal which it outputs on receive line 43b.

The first wavelength division multiplexer/demultiplexer 50a may be configured to receive the nacelle-bound light from the control and monitoring networks in the rotor and multiplex the nacelle-bound light onto the linking optical fibre 8. As explained above, nacelle-bound light from the control network is at a wavelength λ2 and nacelle-bound light from the monitoring network is at a wavelength λ4.

The second wavelength division multiplexer/demultiplexer 50b may be configured to receive rotor-bound light from the control and monitoring networks in the nacelle and multiplex the rotor-bound light onto the linking optical fibre 8. As explained above, rotor-bound light from the control network is at a wavelength λ1 and rotor-bound light from the monitoring network is at a wavelength λ3.

The first wavelength division multiplexer/demultiplexer 50a is also configured to demultiplex the rotor-bound light from the linking optical fibre 8 and route it to either the control network or the monitoring network based on a wavelength of the rotor-bound light from the linking optical fibre 8. Rotor-bound light at the wavelength λ1 is routed to the control network in the rotor via the transceiver/diplexer 51a and rotor-bound light at the wavelength λ3 is routed to the monitoring network in the rotor via the transceiver/diplexer 52a.

The second wavelength division multiplexer/demultiplexer 50b is also configured to demultiplex the nacelle-bound light from the linking optical fibre 8 and route it to either the control network or the monitoring network based on a wavelength of the nacelle-bound light from the linking optical fibre 8. Nacelle-bound light at the wavelength λ2 is routed to the control network in the nacelle via the transceiver/diplexer 51b and nacelle-bound light at the wavelength λ4 is routed to the monitoring network in the nacelle via the transceiver/diplexer 52b.

Each diplexer 60a, 60b, 61a, 61b may comprise a passive element such as an angled filtering mirror which reflects light at one wavelength but is transparent at another wavelength. Thus, for example, the diplexer 60a may reflect the rotor-bound light at wavelength λ1 but be transparent to the nacelle-bound light at wavelength λ2.

Optionally each wavelength division multiplexer/demultiplexer 50a, 50b may use a similar passive element, such as an angled filtering mirror, to perform its multiplexing and/or demultiplexing function.

The use of passive elements, such as angled filtering mirrors, is advantageous and enabled by the wavelength-division-multiplexing aspects of the design.

Although the invention has been described above with reference to one or more preferred embodiments, it will be appreciated that various changes or modifications may be made without departing from the scope of the invention as defined in the appended claims.

1. A wind turbine comprising:
a nacelle;
a rotor rotationally mounted to the nacelle, the rotor comprising a hub, and blades extending from the hub;
a control network comprising control-network nodes connected by a first network, the control-network nodes comprising one or more first control-network nodes in the rotor and one or more second control-network nodes in the nacelle;
a monitoring network comprising monitoring-network nodes connected by a second network, the monitoring-network nodes comprising one or more first monitoring-network nodes in the rotor and one or more second monitoring-network nodes in the nacelle;
an optical fibre which is shared by the first and second networks and extends between the nacelle and the rotor;
a first wavelength division multiplexer/demultiplexer in the rotor; and
a second wavelength division multiplexer/demultiplexer in the nacelle, wherein:
the first wavelength division multiplexer/demultiplexer is configured to receive nacelle-bound light and multiplex the nacelle-bound light onto the optical fibre;
the first wavelength division multiplexer/demultiplexer is configured to demultiplex rotor-bound light from the optical fibre and route it to either the control network or the monitoring network based on a wavelength of the rotor-bound light;
the second wavelength division multiplexer/demultiplexer is configured to demultiplex the nacelle-bound light from the optical fibre and route it to either the control network or the monitoring network based on a wavelength of the nacelle-bound light; and
the second wavelength division multiplexer/demultiplexer is configured to multiplex the rotor-bound light onto the optical fibre.

2. The wind turbine according to claim 1, wherein at least one of the first monitoring-network nodes and at least one of the second monitoring-network nodes comprises a monitoring element configured to monitor the wind turbine and generate monitoring data.

3. The wind turbine according to claim 2, wherein the second network is configured to receive the monitoring data and communicate the monitoring data to a substation remote from the wind turbine.

4. The wind turbine according to claim 1, wherein the second network is configured to communicate monitoring network data to the monitoring-network nodes.

5. The wind turbine according to claim 4, wherein the monitoring network data comprises configuration data or command data.

6. The wind turbine according to claim 1, wherein at least one of the first control-network nodes and at least one of the second control-network nodes comprises a control element configured to control the wind turbine based on control data, and the first optical fibre network is configured to communicate the control data to the control elements.

7. The wind turbine according to claim 1, wherein the first wavelength division multiplexer/demultiplexer and/or the second wavelength division multiplexer/demultiplexer is configured to operate passively.

8. The wind turbine according to claim 1, wherein the optical fibre is a multi-mode optical fibre.

9. The wind turbine according to claim 1, wherein the first wavelength division multiplexer/demultiplexer is in the hub.

10. The wind turbine according to claim 1, wherein the control network and the monitoring network each comprise a respective transmitter in the rotor, and the transmitters in the rotor are configured to generate the nacelle-bound light at respective wavelengths and feed it to the first wavelength division multiplexer/demultiplexer.

11. The wind turbine according to claim 1, wherein the control network and the monitoring network each comprise a respective transmitter in the nacelle, and the transmitters in the nacelle are configured to generate the rotor-bound light at respective wavelengths and feed it to the second wavelength division multiplexer/demultiplexer.

12. The wind turbine according to claim 1, wherein the control network and the monitoring network each comprise a respective receiver in the rotor, and the receivers in the rotor are each configured to receive the rotor-bound light at respective wavelengths from the first wavelength division multiplexer/demultiplexer and convert the rotor-bound light into an electrical signal.

13. The wind turbine according to claim 1, wherein the control network and the monitoring network each comprise a respective receiver in the nacelle, and the receivers in the nacelle are each configured to receive the nacelle-bound light at respective wavelengths from the second wavelength division multiplexer/demultiplexer and convert the nacelle-bound light into an electrical signal.

14. A method of handling communication signals in networks of a wind turbine, the wind turbine comprising: a nacelle; a rotor rotationally mounted to the nacelle, the rotor comprising a hub, and blades extending from the hub; a control network comprising control-network nodes connected by a first network, the control-network nodes comprising one or more first control-network nodes in the rotor and one or more second control-network nodes in the nacelle; a monitoring network comprising monitoring-network nodes connected by a second network, the monitoring-network nodes comprising one or more first monitoring-network nodes in the rotor and one or more second monitoring-network nodes in the nacelle; and an optical fibre which is shared by the first and second networks and extends between the nacelle and the rotor, the method comprising:
receiving nacelle-bound light and multiplexing the nacelle-bound light onto the optical fibre;
demultiplexing rotor-bound light from the optical fibre and routing it to either the control network or the monitoring network based on a wavelength of the rotor-bound light;
demultiplexing the nacelle-bound light from the optical fibre and routing it to either the control network or the monitoring network based on a wavelength of the nacelle-bound light; and
multiplexing the rotor-bound light onto the optical fibre.

15. The method according to claim 14, further comprising:
by at least one node of the first control-network nodes and at least one node of the second control-network nodes: controlling the wind turbine based on control data; and
communicating the control data to the at least one node of the first control-network nodes and the at least one node of the second control-network nodes.

16. The method according to claim 14, wherein at least one of the first monitoring-network nodes and at least one of the second monitoring-network nodes comprises a monitoring element configured to monitor the wind turbine and generate monitoring data.

17. The method according to claim 16, further comprising, by the second network:
receiving the monitoring data; and
communicating the monitoring data to a substation remote from the wind turbine.

18. The method according to claim 14, further comprising, by the second network:
communicating monitoring network data to the monitoring-network nodes.

19. The method according to claim 18, wherein the monitoring network data comprises configuration data or command data.
